(19) United States
(12) Patent Application Publication
(10) Pub. No.: US 2025/0324942 A1
(43) Pub. Date: Oct. 23, 2025

(54) SYSTEMS AND METHODS TO MONITOR ANIMALS AND RELATED CONTROLS

(71) Applicant: Ford Global Technologies, LLC, Dearborn, MI (US)

(72) Inventor: Keith Weston, Canton, MI (US)

(73) Assignee: Ford Global Technologies, LLC, Dearborn, MI (US)

(21) Appl. No.: 18/639,701

(22) Filed: Apr. 18, 2024

(51) Int. Cl. A01K 11/00

(52) U.S. Cl. CPC A01K 11/006

(57) ABSTRACT

A vehicle configured to monitor animals and perform control actions is disclosed. The vehicle may include a detection unit and a processor. The detection unit may be configured to capture inputs associated with an animal in proximity to the vehicle. The processor may be configured to obtain the inputs from the detection unit. Based on the inputs, the processor may determine an animal presence in proximity to the vehicle. Responsive to determining the animal presence in proximity to the vehicle, the processor may transmit the inputs and a vehicle location to a server.

### FIELD

The present disclosure relates to vehicles, and more particularly to a vehicle that may monitor animals (including pets and wildlife) in proximity to the vehicle, and perform an action based on the monitoring.

### BACKGROUND

Pets such as dogs and cats sometimes wander to places where their owners may not know where they are. There exists various systems/devices and services to reunite lost pets with their owners. Although conventional systems provide many benefits to the pet owners, there may be instances where the pet owners may desire additional means to find their lost pets.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system to monitor animals and perform a control action, in accordance with the present disclosure.

FIG. 3 depicts example actions performed by a vehicle, in accordance with the present disclosure.

FIG. 4 depicts a flow diagram of an example method to monitor animals and perform a control action, in accordance with the present disclosure.

### DETAILED DESCRIPTION

### Overview

The present disclosure describes a vehicle configured to determine an animal presence in proximity to the vehicle, and perform a predetermined action responsive to determining the animal presence. In some aspects, the vehicle may capture animal images (e.g., via vehicle camera(s)), determine the animal presence by analyzing the animal images, and transmit the animal images to a server. In further aspects, the vehicle may transmit a vehicle location to the server at which the animal is seen by the vehicle. In some aspects, the server may store information associated with lost pets or pet of interests. The information may include pet description/profile/images, pet's last known location, pet's owner details including owner's contact details, recommended search radius based on pet's maximum velocity/date/time when the pet was last seen, and/or the like.

In some aspects, the server may receive the animal images from the vehicle, correlate the animal images with the pet information stored in the server, and determine that the animal detected by the vehicle may be a lost pet or a pet of interest. In an exemplary aspect, the server may perform image analysis on the animal images obtained from the vehicle and the pet images stored on the server, and may determine a matching percentage between the animal and pet images based on the image analysis. When the matching percentage is greater than a threshold value, the server may determine that the animal detected by the vehicle is a lost pet. Responsive to such determination, the server may fetch the pet owner's contact details from the server's database, and may output a notification to a pet owner's user device. The notification may include the animal images captured by the vehicle and the vehicle location. In addition, the server may output another notification to an animal recovery agency that may facilitate in re-uniting the animal/pet of interest with the pet owner.

Alternatively, instead of transmitting the animal images to the server (to determine whether the animal is the pet of interest or not), the vehicle may transmit a request to the server to obtain the information associated with lost pets or pet of interests. The server may receive the request, and may transmit the information to the vehicle responsive to receiving the request. The vehicle may receive the information from the serve, correlate the information with the animal images captured by the vehicle camera(s), and determine that the animal detected by the vehicle may be a pet of interest based on the correlation, in the manner described above. Responsive to such determination, the vehicle may transmit the animal images and the vehicle location to the server. In addition, the vehicle may output a notification to the server indicating that the vehicle has detected the pet of interest. The server may receive such inputs/information from the vehicle, and then output the notification to the pet owner's user device.

In further aspects, the vehicle may determine the animal presence by using a pet tracking device such as a pet chip or a tracking collar worn by the animal/pet of interest, via a vehicle's telematics control unit (TCU). When the vehicle determines the animal presence, the vehicle may activate the vehicle camera(s) to capture images around the vehicle. The vehicle camera may then capture the animal images, which may be transmitted to the server as described above.

In further aspects, the vehicle may obtain additional inputs from the server, responsive to determining that the animal is a pet of interest. The additional inputs may include, for example, pre-stored messages that may be uploaded by the respective pet owner on the server. The pre-stored message may be in the pet owner's voice, which may facilitate the vehicle to interact with the animal/pet of interest in the pet owner's voice. Responsive to obtaining the additional inputs, the vehicle may output the pre-stored message via a vehicle speaker or sound exciter. In some aspects, the messages may not be pre-stored, and may be obtained in real-time.

The systems and methods described herein may provide various advantages. For example, the system (e.g., a vehicle) may be configured to reunite lost pets with respective pet owners. The vehicle may automatically determine the animal presence when the vehicle may be moving or parked in a parking facility, and perform actions to re-unite the lost pet with the pet owner. The vehicle may also use the vehicle's speakers to efficiently interact with the lost pet.

The other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

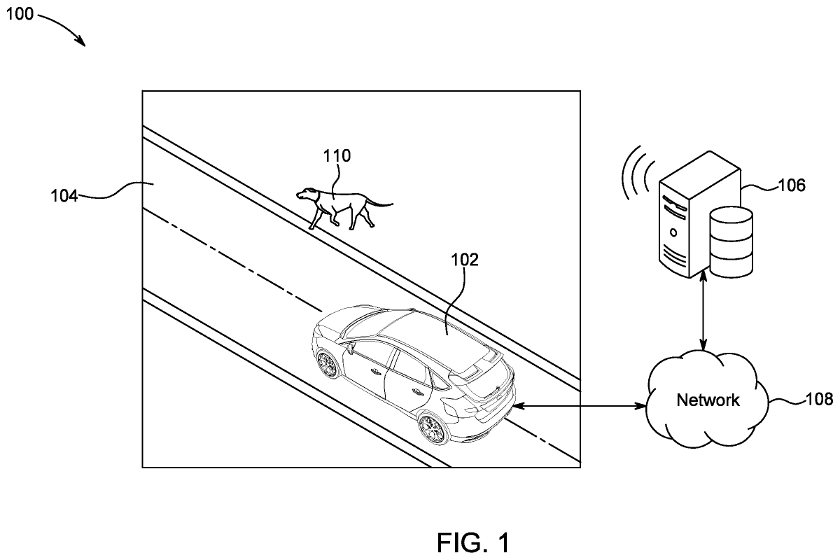

FIG. 1 depicts an example environment 100 in which techniques and structures for providing the systems and methods disclosed herein may be implemented. The environment 100 that may include a vehicle 102 that may be traveling on a road network 104. The vehicle 102 may take the form of any passenger or commercial vehicle such as a car, a work vehicle, a crossover vehicle, a truck, a van, a minivan, a taxi, a bus, etc. The vehicle 102 may be a manually driven vehicle, or may be configured to operate in a partially/fully autonomous mode, and may include any powertrain such as a gasoline engine, one or more electrically-actuated motor(s), a hybrid system, etc.

The vehicle 102 may be communicatively coupled to a server 106 via a network 108. The network 108 illustrates an example communication infrastructure in which the connected devices discussed in various embodiments of this disclosure may communicate. The network 108 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The server 106 may store a database including information of lost pets or pet of interests. The information may include pet description/profile/images, pet last known location, pet owner details including owner contact details, recommended search radius based on pet's maximum velocity/date/time when the pet was last seen, and/or the like. In some aspects, the server 106 may determine/recommend the search radius based on an animal type and a top speed associated with the pet/animal. In some aspects, the server 106 may transmit the information to the vehicle 102 when the vehicle 202 transmits a request to the server 106 seeking the information associated with the pet of interest.

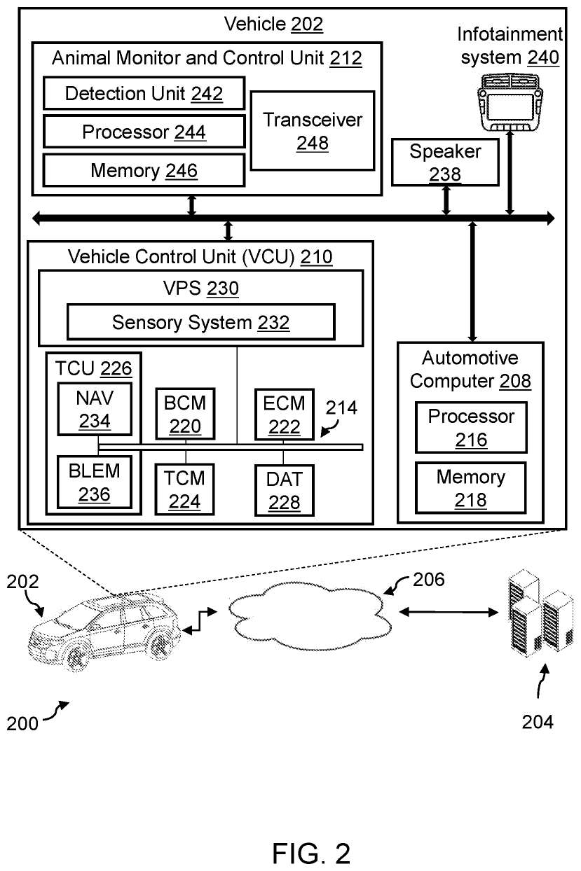

The vehicle 102 may include an animal monitor and control unit (shown as animal monitor and control unit 212 in FIG. 2) that may be configured to determine a presence of an animal 110 in proximity of the vehicle 102, and perform a predetermined control action responsive to detecting the animal presence. The animal may include pets (such as dogs and cats), wildlife, reptiles, and/or the like. In some aspects, the vehicle 102 may determine the animal presence when the vehicle 102 may be moving on the road network 104 or when the vehicle 102 may be parked.

In some aspects, the vehicle 102 (e.g., the animal monitor and control unit or “unit”) may determine the animal presence by using inputs obtained from a vehicle sensor suite such as a vehicle camera (e.g., a vehicle exterior camera), a telematics control unit (TCU) (shown as TCU 226 in FIG. 2), and/or the like. Responsive to determining the animal presence, the vehicle 102 may communicate animal information to the server 106. For example, the unit may transmit one or more animal images captured by the vehicle camera (as “first inputs”) to the server 106. In addition, the unit may transmit a vehicle location (as the first inputs) to the server 106 at which the animal 110 was seen by the vehicle 102.

In some aspects, the server 106 may receive the animal information (such as the animal images) or the first inputs from the vehicle 102, and may correlate the animal information with the pet description/profile (or information associated with lost pets) that may be stored in the server 106. For example, the server 106 may perform image analysis of the animal images to extract animal characteristics (such as height, color, animal type, animal features, etc.), and match/correlate the extracted animal characteristics with the pet description/profile stored in the server 106. The server 106 may determine whether the animal 110 is the pet of interest based on the correlation. For example, when the server 106 determines that the matching/correlation percentage of the pet description/profile with the extracted animal characteristics is greater than a predefined threshold, the server 106 may determine that the animal 110 is the lost pet or a pet of interest. On the other hand, when the server 106 determines that the matching percentage is less than the predefined threshold, the server 106 may determine that the animal 110 may be a stray animal or a wild animal. Responsive to determining that the animal 110 is the pet of interest or the lost pet, the server 106 may output a notification to a pet owner (specifically to a user device associated with the pet owner, based on the pet owner details stored on the server 106). The notification may include the animal information (e.g., the animal images captured by the vehicle camera) and the vehicle location obtained from the vehicle 102.

In alternative aspects, instead of directly transmitting the animal information to the server 106 responsive to determining the animal presence, the vehicle 102 may transmit a request to the server 106 to obtain the information associated with the pet of interest (or “second inputs”) responsive to determining the animal presence. The server 106 may transmit the information associated with the pet of interest or the second inputs to the vehicle 102, when the server 106 receives the request from the vehicle 102. Responsive to obtaining the second inputs from the server 106, the vehicle 102 may correlate the first inputs with the second inputs as described above, and determine that the animal 110 may be the pet of interest based on the correlation. A person ordinarily skilled in the art may appreciate that in this aspect, the vehicle 102 is performing the correlation; however, in the aspect described above, the server 106 is performing the correlation to determine whether the animal 110 is the pet of interest.

In some aspects, when the vehicle 102 performs the correlation, the vehicle 102 may transmit the first inputs (including the vehicle location) to the server 106 when the vehicle 102 determines that the animal 110 is the pet of interest. The server 106 may then output the notification to the pet owner device, in the manner described above.

In further aspects, the vehicle 102 may obtain pre-stored messages associated with the pet of interest from the server 106, responsive to determining that the animal 110 is the pet of interest. The pre-stored messages may be voice messages recorded by the pet owner that may be in a pet owner's voice. The vehicle 102 may output the pre-stored messages via a vehicle exterior speaker or sound exciter when the vehicle 102 may be located in proximity to the animal 110, to attract the attention of the animal 110 (and help re-unite the pet with the pet owner). In some aspects, the pre-stored messages may include one or more commands (e.g., “sit”, “stay”, etc.) that may assist in handling the animal 110/pet of interest in the pet owner's voice.

Further vehicle details are described below in conjunction with FIG. 2.

The vehicle 102 and the server 106 may implement and/or perform operations, as described here in the present disclosure, in accordance with the owner manual and safety guidelines. In addition, any action taken by the vehicle owner or pet owner based on notifications provided by the vehicle 102 or the server 106 should comply with all the rules specific to the location and operation of the vehicle 102 (e.g., Federal, state, country, city, etc.). The notifications, as provided by the vehicle 102 or the server 106, should be treated as suggestions and only followed according to any rules specific to the location and operation of the vehicle 102.

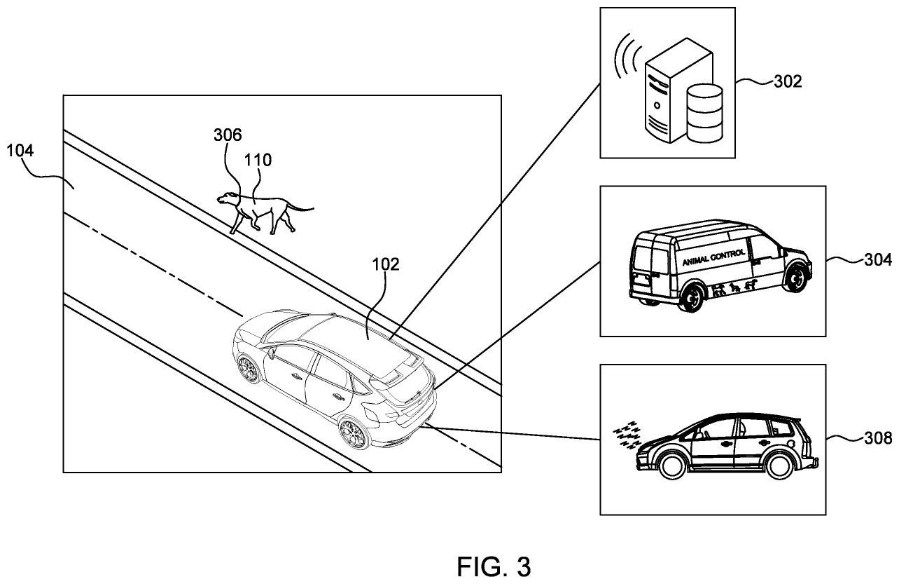

FIG. 2 illustrates a block diagram of an example system 200 to monitor animals and perform a control action, in accordance with the present disclosure. While explaining FIG. 2, references will be made to FIG. 3. FIG. 3 depicts example actions performed by a vehicle, in accordance with the present disclosure.

The system 200 may include a vehicle 202 and a server 204, which may be communicatively coupled to each other via a network 206. The vehicle 202 may be same as the vehicle 102, the server 204 may be same as the server 106, and the network 206 may be same as the network 108.

The vehicle 202 may include a plurality of units including, but not limited to, an automotive computer 208, a Vehicle Control Unit (VCU) 210, and an animal monitor and control unit 212 (or unit 212). The VCU 210 may include a plurality of Electronic Control Units (ECUs) 214 disposed in communication with the automotive computer 208.

The automotive computer 208 and/or the unit 212 may be installed anywhere in the vehicle 202, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable storage medium or memory storing an animal monitor and control program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers (e.g., the server 204), and other vehicles operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a telematics control unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“lidar”) sensor, door sensors, proximity sensors, temperature sensors, wheel sensors, ambient weather or temperature sensors, vehicle interior and exterior cameras, steering wheel sensors, a vehicle gyroscope, a vehicle magnetometer, ultrasonic sensors, etc. In some aspects, the vehicle sensory system 232 may be configured to capture inputs associated with the animal 110 in proximity to the vehicle 202. For example, the vehicle exterior camera may capture images around the vehicle 202, which may include animal images and animal facial expressions (e.g., to see how the animal 110 reacts when the animal 110 hears the pet owner's voice), etc. In some aspects, the vehicle camera may capture the animal images automatically or based on user inputs. In further aspects, the vehicle camera may capture the animal images when the vehicle 202 may be parked or when the vehicle 202 may be moving on the road network 104. The vehicle sensory system 232 may be further configured to transmit such “sensor inputs” (or “first inputs”) to the unit 212 at a predefined frequency.

In some aspects, the VCU 210 may control vehicle operational aspects and implement one or more instruction sets received from the server 204, from one or more instruction sets stored in the memory 218, including instructions operational as part of the unit 212.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236 or BUN (BLE, UWB, NFC module), a Wi-Fi transceiver, an ultra-wideband (UWB) transceiver, and/or other wireless transceivers (not shown in FIG. 2) that may be configurable for wireless communication (including cellular communication) between the vehicle 202 and other systems (e.g., the server 204), computers, and modules. The TCU 226 may be disposed in communication with the ECUs 214 by way of a bus. In some aspects, the TCU 226 may be configured to communicate with a tracking device (such as a pet chip, a tracking collar, etc.) worn by the animal 110, and may detect the animal presence by communicating with the tracking device. Stated another way, the TCU 226 may capture inputs associated with the animal 110 in proximity to the vehicle 202, via the tracking device. The tracking device may be any conventional smart tracking device worn by the animal 110. In further aspects, the TCU 226 may be configured to determine a real-time vehicle location via the NAV receiver 234.

The ECUs 214 may control aspects of vehicle operation and communication using inputs from human drivers, inputs from the automotive computer 208, the unit 212, and/or via wireless signal inputs/command signals received via the wireless connection(s) from other connected devices, such as the server 204, a user device associated with the vehicle user, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers 238 (including vehicle exterior speaker or sound exciter), wipers, door locks and access control, various comfort controls, vehicle features, vehicle buttons, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 240 (or a vehicle Human-Machine Interface (HMI)). The infotainment system 240 may include a touchscreen interface portion, and may include speech and/or voice recognition features, biometric identification capabilities that may identify users based on facial recognition, speech and/or voice recognition, fingerprint identification, or other biological identification means. In other aspects, the infotainment system 240 may be further configured to receive user instructions via the touchscreen interface portion, and/or output or display notifications, navigation maps, etc. on the touchscreen interface portion. In additional aspects, the infotainment system 240 may be configured to enable the vehicle user to operate the speaker 238 and communicate information with the server 204.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered as limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 202, may include a detection unit 242, a processor 244, a computer-readable memory 246, and a transceiver 248, which may be communicatively coupled to each other.

The detection unit 242 may be configured to capture inputs associated with the animal 110 in proximity to the vehicle 202. The detection unit 242 may monitor the animal presence based on inputs from the vehicle sensory system 232 and/or the TCU 226. In some aspects, the detection unit 242 may be part of the vehicle sensory system 232 and/or the TCU 226. Further, the detection unit 242 may transmit inputs/information captured by the detection unit 242 (e.g., animal images or animal video) to the processor 244, via the transceiver 248.

The processor 244 and the memory 246 may be same as or similar to the processor 216 and the memory 218, respectively. In some aspects, the processor 244 may utilize the memory 246 to store programs in code and/or to store data for performing aspects in accordance with the disclosure. The memory 246 may be a non-transitory computer-readable storage medium or memory storing the animal monitor and control program code. In some aspects, the memory 246 may further store the information associated with the pet of interest that may be obtained from the server 204.

In operation, the processor 244 may obtain the first inputs from the detection unit 242 (via the transceiver 248), and determine the animal presence based on the first inputs. For example, the processor 244 may obtain animal images from the vehicle exterior camera, perform image analysis on the animal images, and determine the animal presence in proximity to the vehicle 102 based on the image analysis. Responsive to determining the animal presence in proximity to the vehicle 202, the processor 244 may perform a predetermined action. In some aspects, the predetermined action may include transmitting the first inputs to the server 204, via the transceiver 248, as shown in a view 302 of FIG. 3. The predetermined action may further include transmitting the vehicle location (as a part of the first inputs, determined via the NAV receiver 234) to the server 204 via the transceiver 248. In some aspects, the processor 244 may fetch the vehicle location from the TCU 226/NAV receiver 234 and transmit the vehicle location to the server 204, when the processor 244 determines the animal presence in proximity to the vehicle 102 based on the image analysis.

In some aspects, the server 204 may obtain the first inputs from the vehicle 202, and may correlate the first inputs with the information associated with the pets of interest that may be pre-stored in the server 204. Based on the correlation, the server 204 may determine that the animal 110 may be a pet of interest or a lost pet. Specifically, the server 204 may perform image analysis of the animal images obtained from the vehicle 202, and identify animal characteristics based on the image analysis, as described above in conjunction with FIG. 1. The server 204 may then match/correlate the animal characteristics with the description of the pets of interest or the information associated with the pets of interest stored on the server 204 to determine whether the animal 110 is a pet of interest. When the animal characteristics matches or correlates with the information associated with a pet of interest, the server 204 may output a notification to a pet owner device associated with the pet of interest. The notification may include the first inputs (e.g., the animal images captured by the detection unit 242) and the corresponding vehicle location. In some aspects, the server 204 may determine that the animal characteristics matches/correlates with the information associated with the pet of interest when the matching/correlation percentage is greater than a predefined threshold. In this manner, the vehicle 202 and the server 204 may facilitate the pet owner to re-unite with the pet of interest/lost pet (or at least inform the pet owner that the lost pet is found by the vehicle 202).

In alternative aspects, responsive to determining the animal presence in proximity to the vehicle 102, the processor 244 may transmit a request to the server 204 to obtain “second inputs” via the transceiver 248 and the network 206, instead of transmitting the first inputs to the server 204 as described above. In this case, responsive to receiving the request from the vehicle 202, the server 204 may transmit the second inputs to the vehicle 202 (via the network 206). The processor 244 may obtain the second inputs from the server 204, via the transceiver 248 and the network 206. In some aspects, the second inputs may include description or information associated with the pet of interest that may be stored on the server 204.

Responsive to obtaining the second inputs, the processor 244 may correlate the first inputs determined by the detection unit 242 with the second inputs obtained from the server 204, and then determine that the animal 110 may be the pet of interest based on the correlation. Specifically, the processor 244 may perform image analysis on the animal images captured by the detection unit 242 to identify the animal characteristics, and then match the animal characteristics with the information associated with pets of interest that may be part of the second inputs. In some aspects, the processor 244 may determine that the animal characteristics matches with the information associated with the pet of interest when the matching/correlation percentage is greater than the predefined threshold. When the animal characteristics matches with the information associated with the pet of interest, the processor 244 may transmit the first inputs (including the vehicle location) to the server 204, via the transceiver 248. The server 204 may then output the notification to the pet owner device, as described above. In addition to transmitting the first inputs to the server 204, the processor 244 may transmit, via the transceiver 248, a notification to a third party device, as shown in a view 304, to facilitate the third party in recovering the animal 100/lost pet and reuniting the animal 110 with the pet owner. The third party may be an animal control agency, an animal recovery/rescue agency, an animal care agency, etc.

In some aspects, when the animal 110 may include a tracking unit such as a pet chip, a tracking collar 306 (shown in FIG. 3) etc., the TCU 226 (or the detection unit 242) may capture inputs from the tracking unit and transmit the inputs to the processor 244, via the transceiver 248. The processor 244 may obtain the inputs from the TCU 226, and may transmit a request/trigger to the vehicle camera (another detection unit) to capture images of the animal 110 that may be detected by the TCU 226. The vehicle camera may then capture the animal images and transmit to the processor 244 via the transceiver 248. The processor 244 may obtain the animal images and transmit the animal images to the server 204, as described above.

In further aspects, the processor 244 may perform another action that may include obtaining additional inputs from the server 204, responsive to determining that the animal 110 is a pet of interest (or the animal 110 is a lost pet). The additional inputs may include a pre-stored message from a pet owner. The pre-stored message may be in a pet owner's voice. The processor 244 may obtain the additional inputs by transmitting a request to the server 204 to provide the pre-stored message, via the transceiver 248. The processor 244 may transmit the request automatically or based on inputs from the vehicle owner. Responsive to obtaining the request, the server 204 may search for the pre-stored message in the database and transmit the pre-stored message to the vehicle 102/processor 244, when the message is available.

The processor 244 may obtain the pre-stored message from the server 204 and may cause the speaker 238 to output the pre-stored message to interact with the animal 110/pet of interest in the pet owner's voice (e.g., to navigate the animal 110 towards to the vehicle 102), as shown in a view 308. In further aspect, the processor 244 may obtain real-time voice messages from the pet owner device via the server 204, and cause the speaker 238 to output the real-time voice messages. In some aspects, the vehicle camera or the detection unit 242 may capture animal's facial expressions after outputting such messages, and transmit real-time animal images to the server 204, to allow the pet owner to view the animal's facial expressions.

In further aspects, the processor 244 may output a notification on the infotainment system 240 to request the driver/vehicle owner to wait or follow the animal 110 until the pet owner arrives at the vehicle location, when the processor 244 determines that the animal 110 is the pet of interest. The driver may view the request and may take the appropriate action.

In some aspects, the processor 244 may perform image analysis of the animal images captured by the detection unit 242, and may determine if a predefined condition associated with the animal 110 may be met based on the image analysis. The predefined condition may be met when there is a medical condition associated with the animal 110. For example, the predefined condition may be met when the processor 244 determines that the animal 110 may be bleeding, has sign of rabies, etc. When such predefined condition is met, the processor 244 may output a notification to the third party device indicating urgency, via the transceiver 248. In some aspects, the processor 244 may determine such predefined condition even if the animal 110 may not be the pet of interest (e.g., when the animal 110 may be a stray dog).

In additional aspects, the processor 244 may determine an animal type based on the first inputs/images obtained from the detection unit 242 or the vehicle sensory system 232. Specifically, the processor 244 may obtain images captured by the vehicle exterior camera, perform image analysis, and characterize the animal 110 or determine the animal type based on the image analysis. For example, the processor 244 may determine whether the animal 110 may be a deer, turtle, alligator, bear, dog, etc. (and/or its breed). The processor 244 may further transmit a notification to another server (not shown) or the server 204 via the transceiver 248, including the information associated with such determination/animal type and the vehicle location on the road network 104 or off-road trail. In this case, the other server or the server 204 may receive the notification from the vehicle 202 about the animal type on the road network 104, and may provide alert messages to other vehicles traveling on the same road network 104. In further aspects, the processor 244 may initiate vehicle-to-vehicle (V2V) or Vehicle-to-everything (V2X) communication to output such notifications or alert messages about the animal type on the road network 104.

Although the present disclosure is directed towards reuniting lost pets with the pet owners, the present disclosure is not limiting to only identifying lost pets. The present disclosure may also be used to reunite lost kids with their parents.

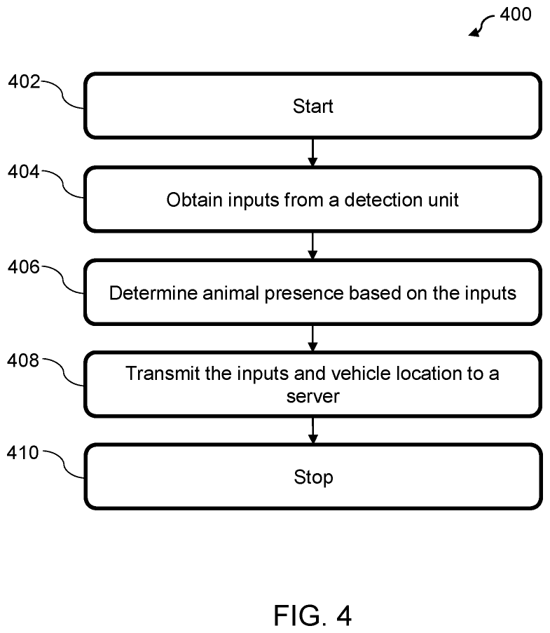

FIG. 4 depicts a flow diagram of an example method 400 to monitor animals and perform a control action, in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the processor 244, the inputs from the detection unit 242 (or the vehicle sensory system 232 and/or the TCU 226).

At step 406, the method 400 may include determining, by the processor 244, the animal presence in proximity to the vehicle 202 based on the inputs obtained from the detection unit 242. At step 408, the method 400 may include transmitting, by the processor 244, the inputs and the vehicle location to the server 204 responsive to determining the animal presence in proximity to the vehicle 202.

The method 400 may end at step 410.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a detection unit configured to capture first inputs associated with an animal in proximity to the vehicle;
a processor communicatively coupled to the detection unit, wherein the processor is configured to:
obtain the first inputs from the detection unit;
determine an animal presence in proximity to the vehicle based on the first inputs; and
transmit the first inputs and a vehicle location to a server responsive to determining the animal presence in proximity to the vehicle.

2. The vehicle of claim 1, wherein the detection unit comprises a vehicle camera, and wherein the first inputs comprise one or more animal images.

3. The vehicle of claim 2, wherein the processor is further configured to:
obtain second inputs from the server responsive to determining the animal presence in proximity to the vehicle, wherein the second inputs comprise information associated with a pet of interest;
correlate the first inputs and the second inputs;
determine that the animal is the pet of interest based on the correlation; and
transmit the first inputs to the server responsive to a determination that the animal is the pet of interest, wherein the server is configured to transmit the first inputs and the vehicle location to a pet owner device.

4. The vehicle of claim 3, wherein the processor is further configured to obtain additional inputs from the server, and wherein the additional inputs comprise a pre-stored message in a voice of a pet owner.

5. The vehicle of claim 4 further comprising a vehicle exterior speaker or a sound exciter, wherein the processor is configured to cause the vehicle exterior speaker or the sound exciter to output the pre-stored message responsive to determining that the animal is the pet of interest.

6. The vehicle of claim 5, wherein the processor is further configured to:
obtain real-time voice messages from the pet owner device via the server; and
cause the vehicle exterior speaker or the sound exciter to output the real-time voices messages.

7. The vehicle of claim 1, wherein the processor is further configured to determine a predefined condition associated with the animal based on the first inputs.

8. The vehicle of claim 7, wherein the predefined condition is a medical condition.

9. The vehicle of claim 7, wherein the processor is further configured to perform a predetermined action when the predefined condition is met.

10. The vehicle of claim 9, wherein the predetermined action comprises outputting a notification to a third party device.

11. The vehicle of claim 1, wherein the processor is further configured to:
determine an animal type based on the first inputs; and
output a notification to another server, wherein the notification comprises the animal type.

12. The vehicle of claim 1, wherein the detection unit further comprises a telematics control unit (TCU) configured to communicate with a tracking device worn by the animal.

13. A method comprising:
obtaining, by a processor, first inputs from a detection unit configured to capture first inputs associated with an animal in proximity to a vehicle;
determining, by the processor, an animal presence in proximity to the vehicle based on the first inputs; and
transmitting, by the processor, the first inputs and a vehicle location to a server responsive to determining the animal presence in proximity to the vehicle.

14. The method of claim 13, wherein the first inputs comprise one or more animal images.

15. The method of claim 14 further comprising:
obtaining second inputs from the server responsive to determining the animal presence in proximity to the vehicle, wherein the second inputs comprise information associated with a pet of interest;
correlating the first inputs and the second inputs;
determining that the animal is the pet of interest based on the correlation; and
transmitting the first inputs to the server responsive to a determination that the animal is the pet of interest, wherein the server is configured to transmit the first inputs and the vehicle location to a pet owner device.

16. The method of claim 15 further comprising obtaining additional inputs from the server, wherein the additional inputs comprise a pre-stored message in a voice of a pet owner.

17. The method of claim 16 further comprising causing a vehicle exterior speaker or sound exciter to output the pre-stored message responsive to determining that the animal is the pet of interest.

18. The method of claim 17 further comprising:
obtaining real-time voice messages from the pet owner device via the server; and
causing the vehicle exterior speaker or the sound exciter to output the real-time voices messages.

19. The method of claim 13 further comprising:
determining a predefined condition associated with the animal based on the first inputs; and
performing a predetermined action when the predefined condition is met.

20. A non-transitory computer-readable storage medium having instructions stored thereupon which, when executed by a processor, cause the processor to:
obtain first inputs from a detection unit configured to capture first inputs associated with an animal in proximity to a vehicle;
determine an animal presence in proximity to the vehicle based on the first inputs; and
transmit the first inputs and a vehicle location to a server responsive to determining the animal presence in proximity to the vehicle.
